(19) United States
(12) Patent Application Publication
(10) Pub. No.: US 2025/0285043 A1
(43) Pub. Date: Sep. 11, 2025

(54) REFACTORING INPUT STRINGS

(71) Applicant: Ford Global Technologies, LLC, Dearborn, MI (US)

(72) Inventors: James Beagle, Horsham (GB); Gary Wallace, Maidstone (GB); Maria Rogers, South Lyon, MI (US); Drake Svoboda, Lake Orion, MI (US); Yao Ge, Northville, MI (US); Kendrick Alden Harper, Temperance, MI (US)

(73) Assignee: Ford Global Technologies, LLC, Dearborn, MI (US)

(21) Appl. No.: 18/600,992

(22) Filed: Mar. 11, 2024

(51) Int. Cl. G06Q 10/0631; G06F 40/40

(52) U.S. Cl. CPC G06Q 10/0631; G06F 40/40

(57) ABSTRACT

A computer that includes a processor and a memory, the memory including instructions executable by the processor to determine when a natural language requirement statement includes an atomic statement using a large language model (LLM) neural network based on a first prompt statement. The first prompt statement can include a first request to label the natural language requirement statement, a description of a requirements language, and the natural language requirement statement. The first output from the LLM includes an explanation statement which indicates reasons the natural language requirement statement is atomic or not atomic. When the LLM determines that the natural language requirement statement is atomic, the LLM can translate the natural language requirement statement into the requirements language based on a second prompt statement that includes a second request to translate the natural language requirement into the requirements language and the natural language requirement statement.

### BACKGROUND

Computers can include instructions to perform data transformations. A class of computer instructions that can perform a large variety of useful data transformations include large language model (LLM) neural networks. An LLM can be trained based on massive natural language datasets to receive as input natural language queries and output responses to the queries.

An LLM is a software program that can be trained on massive amounts of data to receive as input a natural language query or prompt and output a response. The response can be in the same natural language as the query, a different natural language, or a structured language such as a regular grammar or computer programming language. A trained LLM can include billions of parameters. In some examples the response can mimic a natural language response of a human closely enough that a trained LLM can be commonly regarded as artificial intelligence (AI). In other examples, a result output by a trained LLM in response to a natural language query can include a structured language such as a regular grammar or computer language that equals or exceeds the capabilities of a human user.

Training an LLM is accomplished by passing training data through the LLM and comparing the result to a desired result, called ground truth. In some examples the ground truth can be derived from the input data. The LLM encodes the input training data into latent variables and then decodes the latent variables to reconstruct a natural language passage based on parameters. The parameters are updated based on comparing the output of the LLM to the input data to minimize the difference. In examples, the massive amount of training data can be acquired by scanning the Internet for examples of natural language that include samples of the targeted natural language. The training dataset can include news articles, books, social media posts, and technical articles for example.

A trained LLM can be used to translate text from one language into another language. The languages do not have to be natural languages that have evolved based on human usage. An example of an application that uses a trained LLM for language translation is translation of natural language requirements for systems engineering into a formal requirements language. Natural language requirements for systems engineering can be text, written in a natural language such as English, that specifies details of the operation of a product or process, e.g. a system. The purpose of a requirements document for a system engineering task is to specify, for engineers tasked with designing a product or process, aspects of the operation of the product or process in sufficient detail to permit the engineer to select or design the components that comprise the product or process. The components can include mechanical components, electrical and electronic components, and computing components where the computing components can include computer hardware and software. Also included can be interconnection components that operatively connect the mechanical components, electrical and electronic components, and computing components, and packaging components that hold the systems components together.

Natural language requirements can include confusing or ambiguous instructions to engineers tasked with designing systems if not written correctly. To prevent generation of confusing or ambiguous natural language requirements, the International Council on Systems Engineering (INCOSE) has produced the “Guide to Writing Requirements”, INCOSE, San Diego, CA 92111, Jul. 1, 2023. This document describes techniques for expressing requirements statements clearly and precisely in textual form to support analysis and implementation. The INCOSE Guide to Writing Requirements includes a list of 42 rules for writing requirements. These 42 rules can be used to specify a formal requirements language.

### BRIEF DESCRIPTION OF THE DRAWINGS

FIG. 1 is a block diagram of an example computer system.

FIG. 2 is a diagram of an example LLM transformer architecture layer.

FIG. 3 is a diagram of an example LLM.

FIG. 4 is a flowchart diagram of an example process to generate atomic formal requirements language statements from natural language input using an LLM.

### DETAILED DESCRIPTION

This disclosure encompasses training and operating LLMs that provide formal requirements language output. A formal requirements language an artificial language that can be defined by a formal grammar. Formal grammar is a set of rules that identify syntactically correct strings of symbols or tokens that indicate words or phrases. Formal grammar defines combinations of strings that generate syntactically correct compound requirements, e.g. requirements that include multiple statements that specify the operation of one or more system components. Syntactically correct compound requirements that obey the rules of a requirements language can be used to unambiguously specify instructions for designing a system either manually or automatically or a combination of both. A benefit of using a requirements language to specify a product or system is that the specification should then not include contradictory or incomplete data regarding the design, Further, the output specification can be used to automate the design of system components, design of validation tests that confirm that the completed product meets the specifications and design of manufacturing tests that confirm that the product or system was manufactured correctly.

A requirements language specified by outputs as described herein relies on requirements being expressed as atomic statements. A natural language requirement statement is atomic when the natural language requirement statement describes one or more of a single function, a single feature, a single need, a single specification or a single capability of a manufactured product. These are referred to herein as complex requirements language statements. The requirements language specified herein is a language for writing requirements for systems engineering that includes the atomic requirements language statements.

A requirements language that can be used to specify vehicle design is used as an example herein without loss of generality. The requirements language for vehicle design described herein has been developed based on forty-two rules regarding design requirements included in the INCOSE Guide to Writing Requirements. The formal grammar describing the statement types and statement patterns in a requirements language for vehicle design are listed in Table 1:

TABLE 1
Formal requirements language

| NAME/TYPE | PATTERN |
|---|---|
| Ubiquitous | The <system name> shall <system response> |
| Event-Driven | WHEN <trigger><optional precondition> the <system |
| | name> shall <system response> |
| Unwanted | IF <unwanted condition or event>, THEN the <system |
| Behavior | name> shall <system response> |
| State-Driven | WHEN <system state>, the <system name> shall |
| | <system response> |
| Optional | WHERE <feature is included>, the <system name> shall |
| Feature | <system response> |
| Complex | (combinations of above patterns) |

The first five statements in the formal requirements language, Ubiquitous, Event-Driven, Unwanted Behavior, State-Drive, and Optional Feature, are atomic statements, meaning that they define a single state or conditional statement. The last entry, Complex, describes conditional events involving multiple triggers, states, and/or optional features that are combinations of the first five statements. Definition for the elements included in the patterns are included in Table 2:

TABLE 2
Formal Requirements Language Elements

| Element | Definition |
|---|---|
| <system name> | Specifies the system to be designed |
| <system response> | Specifies an output of the system |
| <trigger> | Specifies an input to the system |
| <optional precondition> | Specifies a behavior or state that can precede |
| | an input |
| <unwanted condition or | Specifies a behavior or state to be changed |
| event> | or eliminated |
| <system state> | Specifies the status of the system |
| <feature is included> | Specifies a behavior of the system |

Translating natural language requirements into a formal requirements language presently can be a difficult and error-prone task that requires expertise in both product design and formal requirements language authoring. Translation of natural language requirements into a formal requirements language is typically performed iteratively, with users checking one other's work and no guarantee that the completed work includes grammatically correct formal requirements language statements. Techniques described herein enhance translating natural language requirements into a formal requirements language using an LLM by producing grammatically correct formal requirements language statements in a fixed number of iterations.

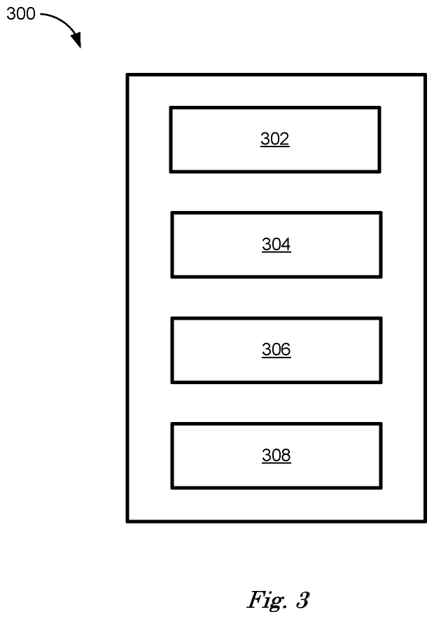

Techniques described herein for generating requirements language statements use prompt engineering to translate natural language requirements into a requirements language using an LLM. Prompt engineering is a technique for producing input text for an LLM that will generate desired output while minimizing iterations and erroneous answers. Prompt engineering will be discussed in relation to FIG. 3, below. Techniques described herein use prompt engineering to identify atomic statements in natural language requirements. Atomic natural language requirements statements can be translated by the LLM into a single statement in one of the forms included in Table 1. In examples where the natural language requirements do not include atomic statements, an LLM can output an evaluation that can be input to the LLM as a prompt to refactor the non-atomic natural language requirements in to atomic statements. The refactored natural language requirements can then be translated by the LLM into one or more atomic statements in the requirements language. The refactored atomic statements can be used to enhance a design process by unambiguously specifying a minimum set of atomic design requirements in a fixed number of iterations.

Disclosed herein is a method including determining when a natural language requirement statement includes an atomic statement using a large language model (LLM) neural network based on a first prompt statement that includes a first request to label the natural language requirement statement, a description of a requirements language, and the natural language requirement statement and where first output from the LLM can include an explanation statement which indicates reasons the natural language requirement statement is atomic or not atomic. When the LLM determines that the natural language requirement statement is atomic, the natural language requirement statement can be translated into the requirements language using the LLM based on a second prompt statement that includes a second request to translate the natural language requirement into the requirements language, the natural language requirement statement, and the description of the requirements language, where second output from the LLM includes an atomic requirements language statement. The LLM can output the atomic requirements language statement. When the first output indicates that the natural language requirement statement is not atomic, the LLM can be used to refactor the natural language requirement statement into a refactored natural language requirement statement based on a third prompt statement that includes a third request to refactor the natural language requirement statement, the description of the requirements language, the explanation statement, and the natural language requirement statement, where third output from the LLM includes the refactored natural language requirement including one or more atomic requirements language statements.

The one or more natural language requirements statements included in the refactored natural language statement can be translated into one or more atomic requirements language statements using the LLM based on a fourth prompt that includes a fourth request to translate the one or more natural language requirement statements included in the refactored natural language statements into the requirements language and the description of the requirements language, where fourth output from the LLM includes the one or more atomic requirements language statements. The LLM can output one or more atomic requirements language statements. The natural language requirement statement can be atomic when the natural language requirement statement describes one or more of a single function, a single feature, a single need, a single specification, or a single capability of a manufactured product. The requirements language can be a language for writing requirements for systems engineering that includes the atomic requirements language statements.

The atomic requirements language statements can include SHALL statements, WHEN statements, IF-THEN statements, WHILE statements, and WHERE statements. The atomic requirements language statements can include combinations of one or more atomic requirements language statements. The LLM can be an attention-based neural network that receives as inputs natural language requirements statements and outputs natural language statements or the atomic requirements language statements. The first prompt and the second prompt can include conditional chaining. The second prompt can include requirements language rules with an explanation from the first prompt. The first prompt and the second prompt can include one or more of an instruction, context data, an output indicator, and input data. The context data can include background data to guide the LLM in performing a processing task included in the instruction. The instruction can include a brief natural language explanation of a processing task that is to be performed by the LLM. The output indicator can be used by the LLM to determine the form and contents of an output text string. The input data is a text string to which the instruction is applied by the LLM in view of the context data to produce the output text string in a format specified by the output indicator.

Further disclosed is a computer readable medium, storing program instructions for executing some or all of the above method steps. Further disclosed is a computer programmed for executing some or all of the above method steps, including a computer apparatus, programmed to determine when a natural language requirement statement includes an atomic statement using an LLM neural network based on a first prompt statement that includes a first request to label the natural language requirement statement, a description of a requirements language, and the natural language requirement statement and where first output from the LLM can include an explanation statement which indicates reasons the natural language requirement statement is atomic or not atomic. When the LLM determines that the natural language requirement statement is atomic, the natural language requirement statement can be translated into the requirements language using the LLM based on a second prompt statement that includes a second request to translate the natural language requirement into the requirements language, the natural language requirement statement, and the description of the requirements language, where second output from the LLM includes an atomic requirements language statement. The LLM can output the atomic requirements language statement. When the first output indicates that the natural language requirement statement is not atomic, the LLM can be used to refactor the natural language requirement statement into a refactored natural language requirement statement based on a third prompt statement that includes a third request to refactor the natural language requirement statement, the description of the requirements language, the explanation statement, and the natural language requirement statement, where third output from the LLM includes the refactored natural language requirement including one or more atomic requirements language statements.

The instructions can include further instructions where the one or more natural language requirements statements included in the refactored natural language statement can be translated into one or more atomic requirements language statements using the LLM based on a fourth prompt that includes a fourth request to translate the one or more natural language requirement statements included in the refactored natural language statements into the requirements language and the description of the requirements language, where fourth output from the LLM includes the one or more atomic requirements language statements. The LLM can output one or more atomic requirements language statements. The natural language requirement statement can be atomic when the natural language requirement statement describes one or more of a single function, a single feature, a single need, a single specification, or a single capability of a manufactured product. The requirements language can be a language for writing requirements for systems engineering that includes the atomic requirements language statements.

The instructions can include further instructions where the atomic requirements language statements can include SHALL statements, WHEN statements, IF-THEN statements, WHILE statements, and WHERE statements. The atomic requirements language statements can include combinations of one or more atomic requirements language statements. The LLM can be an attention-based neural network that receives as inputs natural language requirements statements and outputs natural language statements or the atomic requirements language statements. The first prompt and the second prompt can include conditional chaining. The second prompt can include requirements language rules with an explanation from the first prompt. The first prompt and the second prompt can include one or more of an instruction, context data, an output indicator, and input data. The context data can include background data to guide the LLM in performing a processing task included in the instruction. The instruction can include a brief natural language explanation of a processing task that is to be performed by the LLM. The output indicator can be used by the LLM to determine the form and contents of an output text string. The input data is a text string to which the instruction is applied by the LLM in view of the context data to produce the output text string in a format specified by the output indicator.

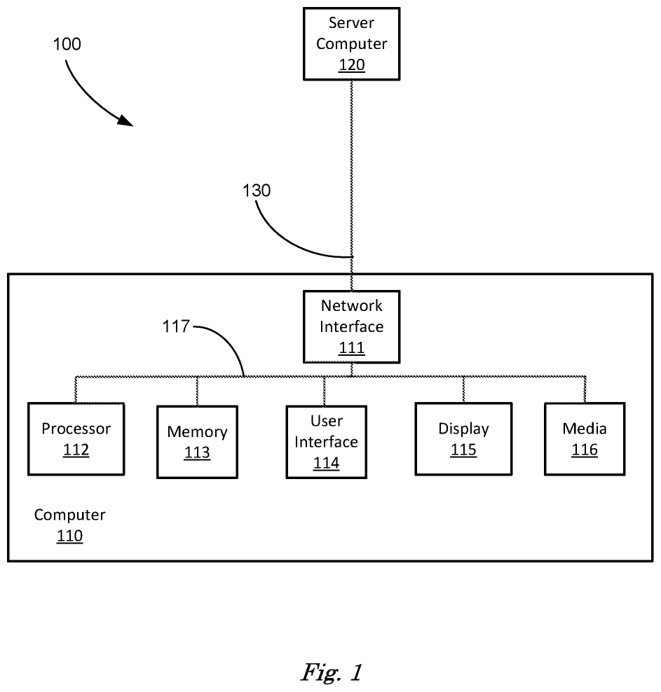

FIG. 1 is a diagram of computing system 100. Computing system 100 includes a computer 110, and a server computer 120 remote from the computer 110. One or more computers 110 can receive data regarding the operation of the computer 110 from a user interface 114. The computer 110 may also operate based on data received from the remote server computer 120. The server computer 120 can communicate with the computer 110 via a network 130 and network interface 111.

Computer 110 includes a processor 112 and a memory 113 such as are known, connected by a bus 117. Further, memory 113 includes one or more forms of computer-readable media, and stores instructions executable by the processor 112 for performing various operations, including as disclosed herein. The computer 110 may include or be communicatively coupled to, i.e., via a communications bus as described further below, more than one computing devices, i.e., controllers or the like included in the computing system 100 for monitoring and controlling various components. The computer 110 network can additionally or alternatively include wired or wireless communication mechanisms such as are known, i.e., Ethernet or other communication protocols.

Via the bus 117, the computer 110 may transmit messages to various devices in computer 110 and receive messages from the various devices, i.e., user interface 114, display 115 and removeable media 116. Alternatively, or additionally, in cases where the computer 110 actually comprises multiple devices, the bus 117 or network 130 may be used for communications between devices represented as the computer 110 in this disclosure.

In addition, the computer 110 may be configured for communicating through a network interface 111 with a remote server computer 120, i.e., a cloud server, via a network 130, which, as described below, includes hardware, firmware, and software that permits computer 110 to communicate with a remote server computer 120 via a network 130 such as wireless Internet (WI-FI®) or cellular networks. Network interface 111 may accordingly include processors, memory, transceivers, etc., configured to utilize various wired and wireless networking technologies, i.e., cellular, BLUETOOTH®, Bluetooth Low Energy (BLE), Ultra-Wideband (UWB), Peer-to-Peer communication, UWB based Radar, IEEE 802.11, and other wired and wireless packet networks or technologies. The computer 110 also includes nonvolatile media 116 such as is known. Computer 110 can log data by storing the data in nonvolatile media 116 for later retrieval and transmittal via the vehicle communication network and a vehicle to network interface 111 to a server computer 120. Nonvolatile media 116 can also be removable for archival storage or transport to another computer 110.

As already mentioned, generally included in instructions stored in memory 113 and executable by processor 112 of the computer 110 are software programs. For example, the computer 110 may include programming to operate one or more software programs such as an neural networks. Using data received in the computer 110, i.e., input data from the user interface 114, the server computer 120, etc., the computer 110 may make various determinations and output data via display 115 or network interface 111. Under interface 114 can include input devices such as a keyboard, pointing devices such as a mouse or trackpad, a scanner, a camera, etc. Output data can also be transmitted to non-volatile media 116 such as disk drives, flash drives, memory cards or printers, etc.

Server computer 120 typically has features in common, e.g., a computer processor and memory and configuration for communication via a network 130, with the vehicle 110 V2I interface 111 and computer 110, and therefore these features will not be described further to reduce redundancy. A server computer 120 can be used to develop and train machine learning software that can be transmitted to a computer 110.

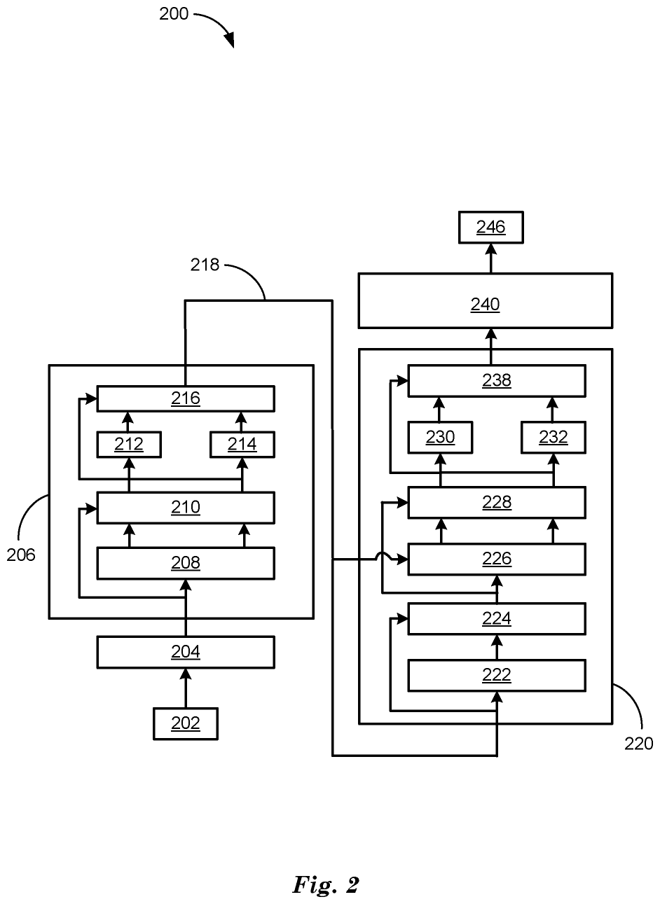

FIG. 2 is a diagram of an example LLM 200 which can be based on a transformer neural network. A transformer neural network can be used to implement an LLM 200 because a transformer neural network can handle large amounts of training data efficiently. Training a transformer neural network can result in excess of billions of parameters being stored for recall at inference time. An LLM 200 is a type of neural network optimized for processing sequential data such as natural language An LLM 200 an attention-based sequence-to-sequence encoder-decoder architecture that can input natural language text, execute instructions included in the input text and output text. Attention-based architectures can process long-range dependencies, where results can be based on words or phrases that are distant from each other in the input data. Attention-based architectures are also good at determining context, where context is defined as underlying circumstances that affect a result output from an LLM 200. Context can be determined based on more than one portion of a sequence input to an LLM 200.

A transformer-based LLM 200 can efficiently be trained using very large datasets. For example, an LLM 200 can produce results efficiently by sampling portions of intermediate results generated by the billions of parameters stored as training data. Differences in sampling between one run of an LLM 200 to the next can cause an LLM 200 to be non-deterministic, meaning that an LLM 200 can produce different results for more than one run based on the same input prompt. Although the design of an LLM 200 is such that strictly deterministic behavior is sometimes not possible, careful prompt design can yield results that are close enough to be useable for the desired purpose without being identical. A close result is a result that indicates the same meaning while being expressed with slightly different wording.

A technique for producing repeatable results is to perform multiple LLM 200 runs for a single prompt. Obtaining these results can be compared using a voting algorithm, where the most frequently occurring response is selected. In examples described herein, very detailed and specific prompts are determined as input data to an LLM. The more detailed and specific examples that are included in a prompt, the more likely similar results will be output for repeated applications of the prompt. The more detailed and specific the input prompts, the less variation in output results will be produced by a trained LLM 200. Generating detailed and specific prompts that result in consistent output results will be described in relation to FIG. 3 below.

LLM 200 includes attention-based processing to efficiently process large input texts. Attention-based processing can encode text as tokens in a multi-dimensional vector. Relationships between pairs of tokens can be encoded as additional vector dimensions that can connect tokens at any distance within the input text in one step to efficiently encode relationships between words or phrases that can be separated in the input prompt 202.

An LLM 200 can include multiple encoder blocks 204 followed by multiple decoder blocks 220. Encoder blocks 204 include multiple layers which determine relationships between tokens extracted from the human-readable text in the input prompt 202 based on parameters determined at training time. The encoded input prompt 202 data is output by an encoder block 204 as latent variables 218, so-called because the latent variables 218 are not typically visible outside of the LLM 200. The latent variables 218 are then processed by one or more decoder blocks 220, which process the tokens and relationships included in the latent variables 218 to generate human-readable text to form output text data 246.

Input prompt 202, which can be input text, is received by positional encoding block 204, which encodes text as a multi-dimensional vector. The multi-dimensional vector includes tokens which indicate parts of speech and links that indicate relationships between words or phrases in the input text that are related syntactically. Tokens are numeric values that indicate input embedding and positional encoding for words or phrases in the input prompt. Input embedding tags the words or phrases in the input prompt with semantic data indicating the part of speech for the words or phrases, such as verb, noun, direct object, indirect object, etc., and positional encoding indicates the positional relationships between tokens in the input prompt.

The positionally encoded vector output by positional encoding block 204 is received by multi-head attention layer 208. Multi-head attention layer 208 is a self-attention processing layer that generates multiple intermediate results in parallel. Multi-head attention layer 208 permits an LLM 200 to determine results based on multiple intermediate results in a single pass. Generating prompts that emphasize relationships between words in input text, provides context by describing relationships between words and generates multiple intermediate results can enhance processing efficiency of an LLM 200 and reduce the effect of non-deterministic behavior of an LLM 200.

Self-attention processing by multi-head attention layer 208 can determine relationships between the tokens in input vector without additional external data. The weights or parameters included in training data for LLM 200 can determine relationships and scores for the relationships between the tokens. Multi-head attention layer 208 can determine multiple relationships and scores between multiple groups of input tokens in the same pass. Multi-head attention layer 208 outputs the relationships and scores to add and norm layer 210 where each of the relationships and scores are separately added to the positionally encoded vector and normalized to keep the data within preset limits, typically 0 to 1. This normalization is performed based on mean and variance values accumulated over the entire training dataset, thereby forcing results to stay within a defined range of values. Normalization prevents anomalous results from skewing the training data, which helps the training converge more quickly on valid results.

The respective multi-head outputs from add and normalize layer 210 are input to multiple feed forward networks 212, 214, where the normalized results are processed in parallel. Feed forward networks 212, 214 are fully connected neural networks that calculate linear and/or non-linear functions based on the input normalized vector data. The output from the feed forward networks 212, 214 is combined with output from the first add and normalize layer 208 at a second add and normalize layer 216. The operation of the second add and normalize layer 216 is the same as described above in relation to the first add and normalize layer 208, where the results are normalized to a selected range, for example 0 to 1, to inhibit anomalous results and enhance training.

Encoder block 204 outputs a latent vector 218 to either a subsequent encoder 206 or to a decoder block 220. Upon exiting the final encoder 206, decoder block 220 receives the latent vector 218 at the first decoder attention layer 222 which flattens the input latent vector 218 to compact the number of connections that relate tokens included in latent vector 218. Following the first decoder attention layer 222 first decoder add and normalize layer 224 normalizes the flattened vector data as discussed above to again permit rapid convergence of results during training. Following the first decoder add and normalize layer 224, second multi-head encoder-decoder attention layer 226 combines latent vector 218 with flattened vector output from first add and normalize layer 224. Output from second multi-head encoder-decoder attention layer 226 is input to second decoder add and normalize layer 228 and then to multiple feed forward networks 230, 232 to process each portion of the flattened vector data in parallel. Feed forward networks 230, 232 are fully connected neural networks that calculate linear and/or non-linear functions based on the input flattened vector data. Following the feed forward networks 230, 232 a third decoder add and normalize layer 238 normalizes the output from the feed forward networks 230, 232 as discussed above.

LLM 200 can include multiple decoder block 220. Following the final decoder block 220, LLM 200 can include a linear layer 240 which inputs the flattened vector data output by the final decoder block 220. Linear layer 240 includes a fully connected neural network that translates the flattened vector data output by the final decoder block 220 into output text data 246 for final output. LLM 200 can execute as a software program installed as instructions in memory 113 of a computer 110. LLM 200 can also be executed as a software program in server computer 120. Input prompt 202 can be received via user interface 114 or via network interface 111 from a server computer 120. The server computer 120 can be included in a networking system such as the Internet, for example.

A trained LLM can be installed in a computing device where the LLM can be operated to generate useful output text. Operating a trained LLM can include providing the LLM with a prompt. A prompt is a text file that includes instructions and data that determine the processing that will be performed by the LLM. The text that will be output from the LLM following processing is based on the contents of the prompt received by the LLM. LLM prompts will be described in relation to FIG. 3, below.

FIG. 3 is a diagram of an example prompt 300 for an LLM 200. Prompt 300 is a text file that includes instructions and data that guides the LLM 200 to produce desired results. Prompt engineering means constructing an LLM 200 prompt 300 that will cause the LLM 200 to generate output text that is desired for a selected task. Good prompt engineering produces unambiguous output text with the fewest iterations. Good prompt engineering enhances the efficiency of LLM 200 operation by reducing the number of iterations required to reach a desired result.

There are many different styles of prompt engineering that produce many different styles of prompts 300 based on the types of LLM 200 output desired. The style of prompt engineering employed in this example includes four prompt 300 sections: instruction 302, context data 304, output indicator 306, and input data 308. Instructions 302 include a brief natural language explanation of the processing task that is to be performed by the LLM 200. The more specific and succinct instruction 302 is, the more likely it is that the LLM 200 will output desired results.

Context data 304 includes background data to guide the LLM 200 in performing the processing task included in instruction 302. Context data 304 is a set of words or phrases that can be used to limit the processing performed by LLM 200 to the desired subject by causing parameters to be selected by the LLM 200 that match words or phrases in context data 304. For example, an LLM 200 can have many thousands of parameters that can be linked to the word “requirements”. By providing context data 304 that indicates that the requirements we are interested in are product design requirements, the number of potential links included in latent variables 218 can be limited to product design requirements. Because an LLM 200 is generally able to only select a subset of the possible parameter links, providing context data 304 can help assure that the subset of parameter links included in latent variables 118 pertain to the desired topic. Properly framing the limits of processing using context data 304 can reduce computing resources, enhance efficiency, and limit the number of iterations required to achieve a desired result from an LLM 200. Output indicator 306 is used by LLM 200 to determine the form and contents of the result. Input data 308 is the text string to which instruction 302 is applied in view of the context data 304 to produce an output text string 246 in the format specified by output indicator 306. Input data 308 can be the last text string appearing in a prompt 300 and can signal the LLM 200 to begin processing.

In addition, some LLMs 200 can include overall settings. An example of an overall setting includes Temperature, which is an integer that governs how diverse or creative answers the LLM 200 generates. Low values of Temperature yield more factual answers and high Temperature values yield more creative results. For tasks performed in these examples LLM 200 Temperature is set to 0.

The prompts 300 can be generated by a prompt control program executing on a computer 110 that inputs natural language requirement text from a user via a user interface 114 or from a file stored in memory 113, media 116, or downloaded from a network 130 via the network interface 111, The natural language prompt can be in plain text, formatted text such as HTML, or other machine-readable text format. The prompt control program can assemble prompts from the natural language requirements text and user determined text files stored at computer 110 or downloaded via network 130. The prompt control program can transmit an assembled prompt to an LLM 200 executing on the computer 110 or more likely via a network 130 such as the Internet to an LLM 200 executing on a server computer 120.

The prompt control program can transmit assembled prompts to an LLM 200 and receive text output from the LLM 200. Upon receiving the output from the LLM 200, the prompt text program can examine text strings in the output and assemble new prompts based on the output and transmit the new prompts to the LLM 200. The prompt control program can repeat this process until the output from the LLM 200 indicates that the output includes atomic statements correctly translated into the requirements language that correspond to the initial natural language requirements by including the string “Atomic: atomic” as the first line of the output. In examples where the LLM 200 determines that the initial natural language requirements do not include atomic statements, the first line of the output includes the string “Atomic: not atomic”. The atomic statements translated into the requirements language can be output to users via the user interface 114, display 115 or stored in memory 113, media 116, or uploaded via network 130 to a server computer 120.

Examples discussed herein use conditional prompt chaining to achieve desired results. Prompt chaining refers to maintaining internal parameters of the LLM 200 resulting from a first prompt 300 to process a second prompt 300, and so forth. Examples discussed herein use conditional chaining, where output text data 246 from a first prompt 300 as in used as portions of a second prompt 300, where processing of the second prompt 300 is conditioned on the output text data 246 from a first prompt 300. For example, a first prompt 300, referred to herein as atomic prompt 300 can include an instruction 302 as listed in Table 3:

TABLE 3
Atomic prompt instruction

Label the following requirements as “atomic” or “not atomic”

Depending upon the natural language requirements input in the Input Data 306 section, the output text data 246 from the atomic prompt can be “atomic” or “not atomic.” The output text data 246 can be included in a second prompt 300 which includes the original natural language requirements and the explanation included in the output text data 246. In response to the second prompt 300 the LLM 200 will either translate atomic natural language prompt into the formal requirements language or refactor the non-atomic natural language prompts into atomic natural language text based on an evaluation included in the output text data 246 in response to the atomic prompt 300.

A second section of atomic prompt 300 can include context data 304. Context data 304 includes additional text that can guide the LLM 200 in reaching a desired response. Including examples and descriptions of types of output text desired is referred to as few-shot learning. Including extensive context data 304 reduces the probability that the LLM 200 will “hallucinate,” meaning that the LLM 200 makes up answers that do not make sense. In this example, the context defines “atomic” and “non-atomic” and provides guidelines for determining the difference between “atomic” and “non-atomic.” The data included in context data 304 is based on INCOSE guidelines as described above. Context data 304 included in atomic prompt 300 is given in Table 4:

TABLE 4
Atomic prompt context

An atomic (or singular) requirement completely describes a **SINGLE** function, feature,
need, specification, or capability.
Non-atomic requirements describe more than one function, feature, need, specification, or
capability and can be broken down into multiple requirements.
Although an atomic requirement should consist of a single function, characteristic or
constraint, it may have multiple conditions under which the requirement is to be met.
An atomic requirement will explicitly and completely describe the requirement and all of its
conditions without ambiguity.
An atomic requirement may also contain additional information about the rationale for the
requirement, the testing and verification method for the requirement, and additional
supplementary information or references; however, this information should be logically
separated from the requirement text into “Rationale”, “Verification Methods”, or “Supplement”
sections accordingly.
You can determine if a requirement is atomic or non-atomic by checking the following:
- Does the requirement describe more than one function, feature, need, specification, or
capability?
- Does the requirement contain combinators or conjunctions like “and”, “or”, “but” or “unless”
to join multiple thoughts, clauses, or functions?
- Is the requirement vague or open ended? Does it use vague language or phrases such as
‘including but not limited to’, ‘etc.’ and ‘and so on’?

Output indicator 306 instructs the LLM 200 regarding the format and content of the output text data 246. In this example, output indicator 306 includes the text in Table 5:

TABLE 5
Atomic prompt output indicator

If the answer to each of the above questions is “no” then the requirement is likely atomic.
Think step-by-step and justify your answer with a brief explanation.

The last element in prompt 300 is input data 308. In this example, the input data 308 is the natural language requirement in Table 6:

TABLE 6
Atomic prompt input data

Requirement:
Auto shifter assemblies, cables, brackets, rods, etc. shall be uniquely identifiable by a unique
alpha-numeric identifier.

In response to an input prompt 300 that includes the text files in Tables 3-6, an LLM 200 can return the output text data 246 included in Table 7:

TABLE 7
Atomic prompt output text data

Atomic: not atomic
Explanation:
This requirement describes only a single specification, that the enumerated components shall
be uniquely identifiable. However, the requirement is vague and open-ended since it does not
completely enumerate which components the requirement applies to and instead uses the
ambiguous phrase ‘etc.’. For this reason, the requirement is not atomic.

Table 7 includes a result equal to “not atomic” and an explanation as to why the input requirements from Table 6 is not atomic. The atomic prompt output text data can be received by a first text processing software program that receives the atomic prompt output text data and extracts the text string following the “Atomic:” string in line one of the atomic prompt output text data and determines that the natural language requirements included in the atomic prompt was determined by the LLM 200 to be “not atomic.” The first text processing software program can assemble a refactoring prompt using the natural language requirements and text included in Tables 8 and 9. Table 8 includes instructions 302 to be received by the LLM 200:

TABLE 8
Refactoring prompt instructions

Refactor the original requirement as one or more atomic requirements using the provided
feedback.
Write a new requirement for each function, feature, need, specification, or capability in the
original requirement.
The requirements that you write must be atomic (or singular).

Table 9 includes the context data 304 to be included in the refactoring prompt. The context includes data regarding formats for requirements language statements to be included as the atomic requirements language statements in the output from the LLM 200 in response to a refactoring prompt.

TABLE 9
Refactoring prompt context

An atomic requirement describes a **SINGLE** function, feature, need, specification, or
capability.
Preserve the meaning of the original requirement without adding any additional details or
specifications.
Give each requirement a title and description.
When possible, use one of the following EARS notation / INCOSE sentence types when
writing the requirement description; however, not all requirement statements will neatly fit
into one of these forms.
- The <system name> shall <system response>.
- When <optional preconditions> <trigger>, the <system> shall <system response>.
- While <in a state>, the <system> shall <system response>.
- If <optional preconditions> <trigger>, then the <system> shall <system response>.
- Where <feature>, the <system> shall <system response>.
Optionally, if the original requirement described the rationale or purpose of the function or
feature, re-write the rationale in a “rationale” section. **DO NOT** define your own
rationale.
Optionally, if the original requirement described the testing or verification methods for the
function or feature, re-write the verification method in the “verification method” section.
**DO NOT** define your own tests or verification method.
Optionally, if the original requirement had any additional information relevant to the function
or feature, place that information in a “supplement” section.
Do not write any details not present in the original in any of the sections.
Cite your sources -- for each detail you write, provide a citation to the relevant portions of the
original requirement.
List all citations you use in the “citations” section of the requirement.
**DO NOT** make up any sources that are not present in the original requirement; each
citation should be a reference to the exact text in the original requirement.

Table 10 includes the output indicator 306 for the refactoring prompt. The refactoring output indicator includes instructions to use the JSON (JavaScript Object Notation) text format for output. JSON is an open standard file format for human-readable text that permits interchange of the output text between web applications and server computers 120, etc. Outputting results in JSON format permits the atomic requirements language statements output by LLM 200 to be received by computer aided design and manufacturing (CAD/CAM) systems and automated test systems.

TABLE 10
Refactoring output indicator

```
Please write the output in the following json format:
’’’json
  ′requirements′: [
      {{
        ″citations″: ″″, // string, required, list of citations separated by new line characters -
write each citation **exactly** as it appears in the original. Number each citation (e.g.
′[<citation number>]: “...” \\n′)
        ″title″: ″″, // string, required, write a concise and descriptive title for the requirement.
      ″description″: ″″, // string, required, requirement statement (typically written in EARS
notation) - describe only a **SINGLE** function, feature, or specification.
        ″verification method″: ″″, // string, optional, description of how to verify or test that the
requirement is met, only include if present in the original, otherwise leave this field as an
empty string (″″). **DO NOT** define your own tests or verification method.
        ″rationale″: ″″, // string, optional, description of the purpose for the requirement or why
it is necessary, only include if present in the original, otherwise leave this field as an empty
string (″″). **DO NOT** define your own rationale.
        ″supplement″: ″″ // string, optional, optional, any additional information relevant to this
requirement (e.g. references to attachments or external resources, contextual information, etc.),
only include if present in the original, otherwise leave this field as an empty string (″″).
    }},
    ]
}}
’’’
```

The refactoring prompt also includes the original natural language requirements and the explanation output by the LLM 200 in response to the atomic prompt. Output from the LLM 200 in response to the refactoring prompt is a text file that includes a string, for example “Refactoring: success”, that indicates whether the LLM 200 has successfully refactored and translated into the natural language requirements in to atomic requirements language statements. When the prompt control program determines that the LLM 200 indicates that the natural language requirements have been successfully translated into atomic requirements language statements, the prompt control program outputs the atomic requirements language statements to the user or stores the atomic requirements language statements at the computer or outputs atomic requirements language statements via network 130 to a server computer 120.

In examples where the prompt control program determines that the LLM 200 has not successfully refactored the natural language requirements into atomic requirements language statements in response to a refactoring prompt, for example by including the string “Refactoring: failure”, the prompt control program can assemble an evaluation prompt. An evaluation prompt includes a portion of the INCOSE rules discussed above that pertain to ambiguity, feasibility and verifiability as defined in the INCOSE document referenced above as context data 304. Table 11 includes an evaluation prompt instruction 302 and an evaluation prompt context data 304 for ambiguity and Table 12 includes an evaluation prompt instruction 302 and an evaluation prompt context data 304 for feasibility and verifiability.

TABLE 11
Evaluation prompt instruction and context for ambiguity

Determine which (if any) of the following INCOSE rules are violated by the requirement.
- R6: Requirements must use appropriate units of measure for all numerical quantities. Almost
all numerical quantities in a requirement require units (e.g. mm, kg, degrees Fahrenheit, etc.).
- R7: Don't use vague terms such as “some”, “any”, “allowable”, “several”, “many”, “a lot of”,
“a few”, “almost always”, “very nearly”, “nearly”, “about”, “close to”, “almost”, and
“approximate”.
- R8: Don't use escape clauses such as such as “so far as is possible”, “as little as possible”,
“where possible”, “as much as possible”, “if it should prove necessary”, “if necessary”, “to the
extent necessary”, “as appropriate”, “as required”, “to the extent practical”, and “if
practicable”.
- R9: Don't use open-ended clauses such as “including but not limited to”, “etc.” and “and so
on.”.
- R28: Express the propositional nature of a condition explicitly for a single action instead of
giving lists of actions for a specific condition. When a list of conditions is given in a
requirement, it must be clear whether all the conditions must hold (a conjunction) or any one
of them (a disjunction).
- R32: Use ‘each’ instead of ‘all’, ‘any’ or ‘both’ when universal quantification is intended.
These rules help determine if a requirement is “ambiguous” or “unambiguous.”
An unambiguous requirement has only one interpretation and will have the same meaning for
the requirement author, the designer, and those doing verification and testing.
It is important that all terms used in the requirement are clearly defined and all conditions are
explicitly stated.
A requirement that is open to multiple interpretations or includes terms or phrases that are not
well defined is “ambiguous.”
Think step-by-step and explain why the requirement violates the rule.
Additionally, correct the rule violations and write an alternative requirement.
Use markdown syntax to identify what changes you made.

TABLE 11
Evaluation prompt instruction and context for feasibility and verifiability

Determine which (if any) of the following INCOSE rules are violated by the requirement.
- R26: Don't use unachievable absolutes such as 100% reliability or 100% availability.
- R33: Define the range of acceptable values associated with numerical quantities. Single-point
values are seldom sufficient and are difficult to test. Use language like “plus or minus”, “+/−”,
“at least”, “at most”, “greater than or equal to”, etc. to define the range of acceptable values.
- R34: Provide specific measurable performance targets. Some words signal unmeasured
quantification, such as ‘prompt’, ‘fast’, ‘routine’, ‘maximum’, ‘minimum’, ‘optimum’, ‘nominal’,
‘easy to use’, ‘close quickly’, ‘high speed’, ‘medium-sized’, ‘best practices', and ‘user-friendly’.
These are ambiguous and need to be replaced by specific quantities.
- R38: Define temporal dependencies explicitly instead of using indefinite temporal keywords.
These rules help determine if a requirement is “verifiable” or “unverifiable.”
A verifiable requirement can be tested and verified to ensure that it has been satisfied.
Think step-by-step and explain why the requirement violates the rule.
Additionally, correct the rule violations and write an alternative requirement.
Use markdown syntax to identify what changes you made.

The evaluation prompt can also include examples of ambiguous, unfeasible, and unverifiable requirements statements gathered from user's experience or from the INCOSE document references above. The evaluation prompt also includes the original natural language requirements as input data 308 along with an output indicator 306 as specified above in Table 10. The prompt control program can input the evaluation prompt to the LLM 200 and receive the text file output by LLM 200 in response to the evaluation prompt. The text file output can include an analysis of the input natural language requirements that indicates which of the INCOSE rules have been broken by the natural language requirements and why they cannot be translated into atomic requirements language statements. The output file generated in response to an evaluation prompt can be output by the prompt control program to users to guide them in re-writing the natural language requirements in a form that can be translated into atomic requirements language statements by the LLM 200. This step is only taken in response to defective natural language requirements that cannot be translated into atomic requirements language statements.

In examples where the LLM 200 determines, in response to the atomic prompt, that the original natural language requirements include atomic statements, the prompt control program can assemble a translating prompt that includes the original natural language requirements as input data 308 along with appropriate instructions 302, context data 304, and output indicator 306 as specified in Table 12 to instruct the LLM 200 to translate the original natural language requirements into atomic requirements language statements.

TABLE 12
Atomic translate instructions, context, and output indicator.

```
Rewrite the original requirement using the provided feedback so that it meets INCOSE
standards and guidelines.
Preserve the original meaning of the requirement without adding any additional details or
specifications.
Give the requirement a title and description.
When possible, use one of the following EARS notation / INCOSE sentence types when
writing the requirement description; however, not all requirement statements will neatly fit
into one of these forms.
- The <system name> shall <system response>.
- When <optional preconditions> <trigger>, the <system> shall <system response>.
- While <in a state>, the <system> shall <system response>.
- If <optional preconditions> <trigger>, then the <system> shall <system response>.
- Where <feature>, the <system> shall <system response>.
Optionally, if the original requirement described the rationale or purpose of the requirement,
re-write the rationale in a ″rationale″ section, otherwise write ″N/A″. **DO NOT** define
your own rationale.
Optionally, if the original requirement described the testing or verification methods for the
requirement, re-write the verification method in the ″verification method″ section, otherwise
write ″N/A″. **DO NOT** define your own tests or verification methods.
Optionally, if the original requirement had any additional information relevant to the
requirement, place that information in a ″supplement″ section, otherwise write ″N/A″.
Do not write any details not present in the original in any of the sections.
Cite your sources -- for each detail you write, provide a citation to the relevant portions of the
original requirement.
List all citations you use in the ″citations″ section of the requirement.
**DO NOT** make up any sources that are not present in the original requirement; each
citation should be a reference to the exact text in the original requirement.
Please write the output in the following json format:
‘‘‘json
{{
  ″citations″: ″″, // string, required, list of citations separated by new line characters - write
each citation **exactly** as it appears in the original. Number each citation (e.g. ′[<citation
number>]: “...” \\n′)
  ″title″: ″″, // string, required, a concise title for the requirement. Come up with your own
descriptive title.
  ″description″: ″″, // string, required, requirement statement (typically written in EARS
notation) - describe only a **SINGLE** function, feature, or specification
  ″verification_method″: ″″, // string, optional, description of how to verify or test that the
requirement is met, only include if present in the original. **DO NOT** define your own tests
or verification method.
  ″rationale″: ″″, // string, optional, description of the purpose for the requirement or why it is
necessary, only include if present in the original. **DO NOT** define your own rationale.
  ″supplement″: ″″ // string, optional, optional, any additional information relevant to this
requirement (e.g. references to attachments or external resources, contextual information, etc.),
only include if present in the original
}}
‘‘‘
```

An atomic translate prompt also includes the original natural language prompt and an explanation, if any, included in the response as indicated in Table 7 to an atomic prompt as indicated by Tables 4, 5, and 6, above. The text file output in response to an atomic translate prompt including the translated atomic requirements language statements can be output to users or stored at computer 110 or transmitted via network 130. Outputting results in JSON format permits the atomic requirements language statements output by LLM 200 to be received by computer aided design and manufacturing (CAD/CAM) systems and automated test systems.

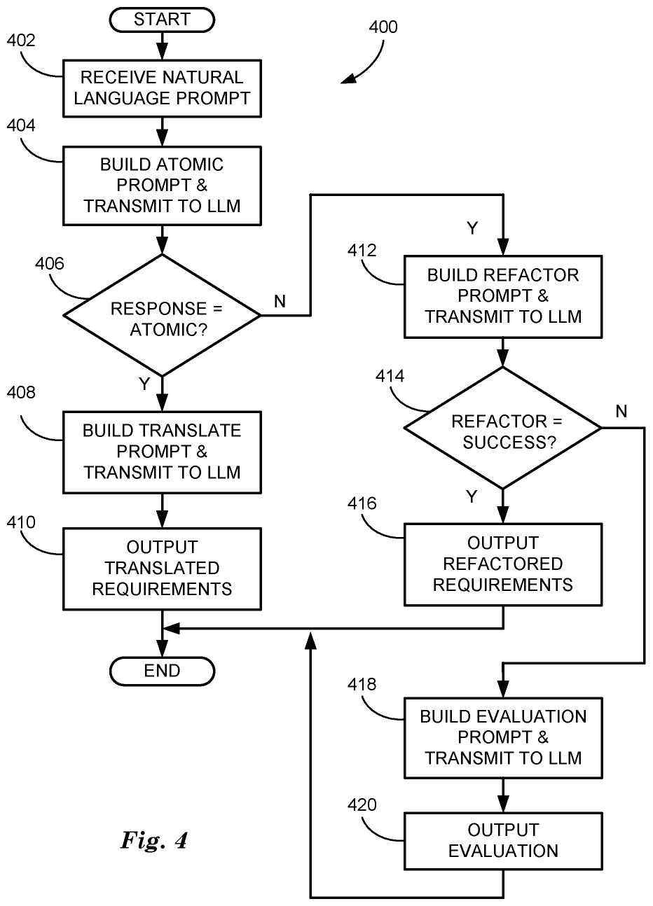

FIG. 4 is a flowchart of a process 400 for translating natural language requirements into atomic requirements language prompts. Process 400 can be implemented in a computer 110, or a combination of a computer 110 and a server computer 120, for example. Process 400 includes multiple blocks that can be executed in the illustrated order. Process 400 could alternatively or additionally include fewer blocks and can include the blocks executed in different orders.

Process 400 begins at block 402, where a prompt control program executing on a computer 110 receives natural language requirements. The natural language requirements can be related to design of a product, process, or system included in a vehicle or other machine, for example.

At block 404 the natural language requirements acquired at block 402 are assembled by the prompt control program into an atomic prompt using the natural language requirements as the input data 308. The input data is assembled with appropriate instructions 302, context data 304, and output indicator 306 as described above in relation to FIG. 3. The assembled atomic prompt can be transmitted to an LLM 200 executing on the computer 110 or via network 130 such as the Internet to an LLM 200 executing on a server computer 120.

At block 406 output text data 246 returned from the LLM 200 to the computer 110 is examined by the prompt control program to determine the result of processing the atomic prompt. When the result of processing the atomic prompt is “atomic”, control passes to block 408. When the result of processing the atomic prompt is “not atomic”, control passes to block 412.

At block 408, the prompt control program assembles a translate prompt based on the received natural language requirements text as the input data 308 and appropriate instructions 302, context data 304, and output indicator 306 as described above in relation to FIG. 3. The translate prompt is transmitted to LLM 200 to translate the natural language requirements into atomic requirements language statements.

At block 410 the translated atomic requirements language statements are output to users, stored at computer 110 and/or transmitted via network to a server computer 120. Following block 410 process 400 ends.

At block 412 the prompt control program assembles a refactor prompt based on the received natural language requirements text and an explanation regarding the reasons the natural language requirements is not atomic included in the output text data 246 as input data 308. The input data 308 is combined with appropriate instructions 302, context data 304, and output indicator 306 as described above in relation to FIG. 3 to form the refactor prompt. The refactor prompt is transmitted to LLM 200 to refactor and translate the natural language requirements into atomic requirements language statements.

At block 414 the text file returned by the LLM 200 in response to the refactor prompt is examined by prompt control program to determine whether the LLM 200 has successfully refactored and translated the natural language requirements into atomic requirements language statements. When the results of processing the refactor prompt is reported as “success” by the LLM 200, process 400 passes to block 416. When the results of processing the refactor prompt is reported as “not success” by the LLM 200, process 400 passes to block 418.

At block 416 the prompt control program outputs the refactored and translated atomic requirements statements to users, stored at computer 110 and/or transmitted via network to a server computer 120. Following block 416 process 400 ends.

At block 418 the prompt control program assembles an evaluation prompt based on the received natural language requirements text and an explanation included in the response to the refactor prompt in output text data 246 as input data 308. Input data 308 is combined with appropriate instructions 302, context data 304, and output indicator 306 as described above in relation to FIG. 3. The evaluation prompt is transmitted to LLM 200 to evaluate the natural language requirements.

At block 420 the prompt control program receives the output text data 246 resulting from processing the evaluation prompt by the LLM 200. The evaluation included in the output text data 246 stating reasons the natural language requirements cannot be translated into atomic requirements language statements is returned to the to users, stored at computer 110 and/or transmitted via network to a server computer 120. Following block 420 process 400 ends.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
determine when a natural language requirement statement includes an atomic statement using a large language model (LLM) neural network based on a first prompt statement that includes a first request to label the natural language requirement statement, a description of a requirements language, and the natural language requirement statement and wherein first output from the LLM includes an explanation statement which indicates reasons the natural language requirement statement is atomic or not atomic;
when the LLM determines that the natural language requirement statement is atomic, translate the natural language requirement statement into the requirements language using the LLM based on a second prompt statement that includes a second request to translate the natural language requirement into the requirements language, the natural language requirement statement, and the description of the requirements language, wherein second output from the LLM includes an atomic requirements language statement; and
output the atomic requirements language statement.

2. The system of claim 1, the instructions including further instructions to:
when the first output indicates that the natural language requirement statement is not atomic, use the LLM to refactor the natural language requirement statement into a refactored natural language requirement statement based on a third prompt statement that includes a third request to refactor the natural language requirement statement, the description of the requirements language, the explanation statement, and the natural language requirement statement and wherein third output from the LLM includes the refactored natural language requirement including one or more atomic requirements language statements; and
translate the one or more natural language requirements statements included in the refactored natural language statement into one or more atomic requirements language statements using the LLM based on a fourth prompt that includes a fourth request to translate the one or more natural language requirement statements included in the refactored natural language statements into the requirements language and the description of the requirements language wherein fourth output from the LLM includes the one or more atomic requirements language statements; and
output the one or more atomic requirements language statements.

3. The system of claim 1, wherein the natural language requirement statement is atomic when the natural language requirement statement describes one or more of a single function, a single feature, a single need, a single specification, or a single capability of a manufactured product.

4. The system of claim 1, wherein the requirements language is a language for writing requirements for systems engineering that includes the atomic requirements language statements.

5. The system of claim 1, wherein the atomic requirements language statements include SHALL statements, WHEN statements, IF-THEN statements, WHILE statements, and WHERE statements.

6. The system of claim 1, wherein the atomic requirements language statements include combinations of one or more atomic requirements language statements.

7. The system of claim 1, wherein the LLM is an attention-based neural network that receives as inputs natural language requirements statements and outputs natural language statements or the atomic requirements language statements.

8. The system of claim 1, wherein the first prompt and the second prompt include conditional chaining.

9. The system of claim 1, wherein the second prompt includes requirements language rules with an explanation from the first prompt.

10. The system of claim 1, wherein first prompt and the second prompt include one or more of an instruction, context data, an output indicator, and input data.

11. The system of claim 10, wherein context data includes background data to guide the LLM in performing a processing task included in the instruction.

12. A method, comprising:
determining when a natural language requirement statement includes an atomic statement using a large language model (LLM) neural network based on a first prompt statement that includes a first request to label the natural language requirement statement, a description of a requirements language, and the natural language requirement statement and wherein first output from the LLM includes an explanation statement which indicates reasons the natural language requirement statement is atomic or not atomic;
when the LLM determines that the natural language requirement statement is atomic, translating the natural language requirement statement into the requirements language using the LLM based on a second prompt statement that includes a second request to translate the natural language requirement into the requirements language, the natural language requirement statement, and the description of the requirements language, wherein second output from the LLM includes an atomic requirements language statement; and
outputting the atomic requirements language statement.

13. The method of claim 12, further comprising, when the first output indicates that the natural language requirement statement is not atomic, using the LLM to refactor the natural language requirement statement into a refactored natural language requirement statement based on a third prompt statement that includes a third request to refactor the natural language requirement statement, the description of the requirements language, the explanation statement, and the natural language requirement statement and wherein third output from the LLM includes the refactored natural language requirement including one or more atomic requirements language statements;
translating the one or more natural language requirements statements included in the refactored natural language statement into one or more atomic requirements language statements using the LLM based on a fourth prompt that includes a fourth request to translate the one or more natural language requirement statements included in the refactored natural language statements into the requirements language and the description of the requirements language wherein fourth output from the LLM includes the one or more atomic requirements language statements; and
outputting the one or more atomic requirements language statements.

14. The method of claim 12, wherein the natural language requirement statement is atomic when the natural language requirement statement describes one or more of a single function, a single feature, a single need, a single specification, or a single capability of a manufactured product.

15. The method of claim 12, wherein the requirements language is a language for writing requirements for systems engineering that includes the atomic requirements language statements.

16. The method of claim 12, wherein the atomic requirements language statements include SHALL statements, WHEN statements, IF-THEN statements, WHILE statements, and WHERE statements.

17. The method of claim 12, wherein the atomic requirements language statements include combinations of one or more atomic requirements language statements.

18. The method of claim 12, wherein the LLM is an attention-based neural network that receives as inputs natural language requirements statements and outputs natural language statements or the atomic requirements language statements.

19. The method of claim 12, wherein the first prompt and the second prompt include conditional chaining.

20. The method of claim 12, wherein the second prompt includes requirements language rules with explanation from the first prompt.
